(19) United States
(12) Patent Application Publication
(10) Pub. No.: US 2006/0184450 A1
(43) Pub. Date: Aug. 17, 2006

(54) Financial product and method which link a debt instrument to a bond

(76) Inventors: Bert Ely, Alexandria, VA (US); Andrew J. Kalotay, New York, NY (US)

Correspondence Address: KELLEY DRYE & WARREN LLP, TWO STAMFORD PLAZA, 281 TRESSER BOULEVARD, STAMFORD, CT, 06901, US

(21) Appl. No.: 11/356,393

(22) Filed: Feb. 16, 2006

Related U.S. Application Data
(60) Provisional application No. 60/654,673, filed on Feb. 17, 2005.
(60) Provisional application No. 60/662,820, filed on Mar. 17, 2005.

(51) Int. Cl. G06Q 40/00

(52) U.S. Cl. 705/38

(57) ABSTRACT

A financial product which is comprised of a note and a bond. The note is linked to the bond in that when an interest rate declines, the note interest rate also is reduced in a predetermined manner and the bond interest rate is reduced in a preselected manner. The interest rate on the note and the bond never go up or in an alternative embodiment go up significantly less than the interest rate increase. Also provided is a method for financing a loan by using a note and linked bond, both of whose interest rates can decline but do not rise. The financial product and the method can be implemented by a computer.

This application claims priority to pending provisional application Ser. No. 60/654,673, filed on Feb. 17, 2005 and to pending provisional application Ser. No. 60/662,820, filed on Mar. 17, 2005.

### BACKGROUND OF THE INVENTION

The present invention relates generally to financial products and, more particularly, to financial products which include a bond and a debt instrument, such as a promissory note. The financial products of the present invention are preferably implemented using computers.

Most people who purchase a large asset such as a home, a condominium, or a car finance the purchase with borrowed funds. In order to minimize monthly payments purchasers extend payments over a prolonged period of time and often secure the debt with a security interest on the purchased asset or another asset. If the asset is real estate, the security interest is usually in the form of a mortgage which includes a mortgage lien (which is recorded against the real estate asset) and a corresponding promissory note which provides for the terms of repayment of the debt. For example, purchasers of homes or condominiums usually obtain long-term mortgages, with promissory notes in which payment of the mortgage principal is amortized over a period of years, generally ten, fifteen or thirty years. Non-amortizing, interest-only, or negative amortization mortgages have become increasingly popular in order to further reduce monthly mortgage payments. In some cases, loans for large sums of money are obtained without a security interest. For example, students and college graduates obtain loans for educational expenses by executing promissory notes which do not have collateral. Secured or unsecured loans may or may not be accompanied by personal guarantees from the borrower and/or from a third party or parties.

Typical home mortgages generally fall into two categories based on interest calculations: fixed-rate mortgages (FRM) and adjustable-rate mortgages (ARM). FRMs generally carry a fixed interest rate until they are fully amortized, unless they are paid off early because the home has been sold, the FRM is refinanced, or the FRM has been paid off for another reason. Sometimes the principal balance of a FRM will be only partially amortized at the time it matures, at which time its remaining balance must be repaid in a “balloon” payment. ARMs carry an interest-rate that adjusts periodically, usually on the anniversary date of the mortgage. ARM payments generally include amortization of the mortgage's principal over a long period, but that is not mandatory. Hybrids of FRMs and ARMs also have been become popular in recent years. For example, a hybrid mortgage may carry a fixed-rate of interest for its first five, seven, ten, or more, years and then, at the end of that period, become an ARM.

Currently, in the United States, mortgages are either kept in portfolio by the institution that funded them, such as a bank, thrift institution, or credit union, or they are sold into the secondary mortgage market. Depository institutions such as banks, thrifts, and credit unions make mortgages or they buy mortgages from independent mortgage brokers. Depository institutions retain ownership of many ARMs they originate or buy while selling the rest of their ARMs into the secondary market. They fund ARMs primarily with their deposits although sometimes with loans (called advances) from a Federal Home Loan Bank (FHLB), a government-sponsored enterprise to which they belong. Depository institutions sometimes retain the ownership of FRMs, usually those of a relatively short maturity, which they fund with a combination of deposits, FHLB advances, and other longer-term borrowings.

Depository institutions sell most of the FRMs (generally with 30-year and 15-year maturities; 10-year and 20-year maturities are not unusual; occasionally maturities extend beyond 30 years) they originate or buy from independent brokers into the secondary market along with some of their ARMs. Mortgages with an initial principal amount under the “conforming” loan limit are usually sold to Fannie Mae or Freddie Mac (F&F). F&F are government-sponsored enterprises Congress created to provide a secondary market for home mortgages. In 2006, the conforming loan limit is $417,000. F&F either hold the mortgages in their portfolio, in which case they fund those mortgages by issuing a mix of callable and non-callable debt of varying maturities, or they securitize the mortgages by pooling them and then selling undivided interests in the pool; the undivided interests are called mortgage-backed securities (MBS). MBS pools vary greatly in size, from a few hundred thousands of dollars containing just one or two mortgages, to tens of thousands of mortgages with an initial principal balance in the pool of several billions of dollars. An MBS pool consisting of just one mortgage can be funded by just one bond if the mortgage originator took back an MBS equal to the unpaid principal of that mortgage.

Ownership of the mortgages that are securitized by F&F is transferred into a trust for which they are the trustee. Mortgages above the conforming loan limit, called “jumbos,” also are sold into the secondary market where they are securitized by investment banks; those securities are usually called private-label or asset-backed securities (ABS). In recent years, the FHLBs have begun buying mortgages from their member banks and thrifts under the Mortgage Partnership Finance (MPF) program. MPF mortgages are funded with unsecured debt issued by the FHLBs.

A relatively small number of home mortgages are made and owned by life insurance companies. These mortgages are usually funded with life-insurance reserves or, in some cases, with FHLB advances. A small number of mortgages are also held by real estate investment trusts (REITs) which specialize in mortgages. Sellers of homes sometimes take back a mortgage on the home. Also, some individuals will make and hold mortgages in their own investment portfolio.

ARMs reflect periodic changes in mortgage rates but they create a risk for the homeowner/mortgagor. If interest rates increase, ARM mortgage payments increase as well. Accordingly, homeowners do not have certainty as to what their monthly mortgage payment will be beyond the date of the next interest-rate reset. By the same measure, ARMs are not suitable investments for investors who need investment yield certainty for a number of years. ARMs wax and wane in popularity, having a particular appeal to higher income homeowners who can easily handle a higher monthly ARM payment should interest rates rise.

FRMs dominate American home financing because they appear to be a relatively safe, one-way bet for homeowners. They give homeowners the guarantee of a fixed mortgage interest rate until they decide to refinance at a lower interest rate. Although most mortgages in the United States do not have a pre-payment penalty, there are significant costs associated with refinancing an existing mortgage. Specifically, the mortgagor who refinances usually must pay appraisal fees, title insurance fees, application fees, settlement fees and a host of other fees, costs and taxes when the refinance mortgage is originated. These origination fees typically amount to several thousand dollars, even in the absence of a pre-payment penalty. The total cost of refinancing FRMs is enormous. Mel Martinez, former Secretary of the U.S. Department of Housing and Urban Development (HUD), reported to Congress in October 2002 that “Americans spend approximately $50 billion each year on settlement costs.” A significant portion of that cost is associated with refinancing FRMs.

Accordingly, there is a need for an improved financial product to make American housing finance and other loan financing more efficient.

### SUMMARY OF THE INVENTION

In accordance with one aspect of the present invention, a financial product includes a debt instrument and a bond expressly or implicitly linked to that debt instrument. The debt instrument includes a provision for decreasing the interest rate on the outstanding debt in a predetermined manner. For example, the interest rate may be decreased periodically or may be decreased based on an external event or events, such as when the prevailing interest rate goes down. But the interest rate of the debt instrument in one embodiment is never increased. In an alternative embodiment, the interest rate is adjusted up only in specified circumstances or is increased significantly less than the increase in the prevailing interest rate. Similarly, the linked bond includes a provision for decreasing the interest rate paid on the bond in a preselected manner.

In accordance with another aspect of the present invention, the financial product includes a mortgage note, with the note having a specified interest rate. The interest rate on the note stays the same or decreases during the term of the mortgage but never increases. In an alternative embodiment, the interest rate on the note increases only in specified circumstances or increases significantly less than the increase in the prevailing interest rate. The note interest rate is decreased in a predetermined manner. The financial product also includes a bond which is linked, expressly or implicitly, to the mortgage note. When the interest rate on the mortgage note is adjusted in a predetermined manner, the interest rate on the bond is adjusted in a pre-selected manner or vice versa.

In accordance with still another aspect of the present invention, the financial product includes a pool of mortgage debt instruments, which is linked to a pool of mortgage bonds or mortgage pass throughs, either expressly or implicitly. The express or implicit linkage provides for predefined adjustments of interest rates of the bond and note, such as for example, based on an external event or events. In one embodiment, the interest rate on the notes is never increased. In another embodiment, the interest rates are increased only in specified circumstances or are increased significantly less than the increase in the prevailing interest rate.

A further aspect of the present invention is a method for financing a loan using a note and a linked bond which comprises the following steps: decreasing the note interest rate in a specified manner upon the occurrence of a specific external event or events, such as, when a specified index changes, but not increasing the note interest rate; decreasing the bond interest rate upon the occurrence of a predetermined external event or events, such as, whenever a preselected index changes in a prespecified manner but not adjusting the bond interest rate otherwise; calculating a new periodic payment amount and/or adjusted amortization schedule for the note whenever the note interest rate is decreased; and calculating a new interest payment and/or an adjusted amortization schedule for the bond whenever the bond interest rate is decreased. In the alternative, a decrease in the interest rate on the bond can be linked to a decrease in the note interest rate which depends on a parameter reflecting interest rates. Similarly, a decrease in the interest rate on the note can be linked to a decrease on the bond interest rate which would depend on a parameter reflecting interest rates. Alternatively, a bond may be linked to a debt instrument through a contractual provision maintaining either a constant or a predefined interest-rate differential between the two instruments over the life of the two instruments, such that when the interest rate on the debt instrument goes down, the effective interest rate on the linked bond is automatically decreased either by the same amount or by a predefined amount.

In accordance with yet another aspect of the present invention, the financial product is a student loan financed by a note and a corresponding bond. The note and the bond are linked such that when the interest rate on the note or the bond is decreased in a predetermined manner, the interest rate on the other of the note or the bond is decreased in a preselected manner. The implementation of the interest rate decrease of the note or the bond depends on an occurrence of an external event, such as a decrease of the prevailing interest rate or of an index which reflects a prevailing interest rate.

In accordance with a further aspect of the present invention, the financial product includes a pool of student loan notes, which is linked to a pool of bonds. This express or implicit linkage provides for a predefined decrease of interest rates of the notes and bonds based on an external event or events, such as for example, when the prevailing interest rate decreases. In one embodiment, the interest rates on the notes are never increased. In another embodiment, the interest rates of the notes are adjusted up only in specified circumstances or are adjusted significantly less than the increase in the prevailing interest rate.

The financial products of the present invention preferably are implemented using computers. For example, computers receive or obtain information which triggers adjustment of the interest rates of the debt instrument and/or the bond, notify the bond holder and the debtor of the changes in the interest rates and re-calculate principal and interest payment schedules when the rate changes are implemented.

### BRIEF DESCRIPTION OF THE DRAWINGS

FIG. 1 shows the parties and transactions involved in financing of a home mortgage in accordance with one embodiment of the present invention.

FIG. 2 shows the parties and transactions involved in servicing a home mortgage in accordance with one embodiment of the present invention.

FIG. 3 is a diagram of the parties and transactions involved in a non-collateralized student loan in accordance with another embodiment of the present invention.

FIG. 4 shows the parties and transactions involved in servicing a non-collateralized student loan in accordance with another embodiment of the present invention.

FIG. 5 shows examples of various alternatives related to the triggering of a downward rate adjustment of debt instruments and bonds in accordance with further embodiments of the present invention.

FIG. 6 shows an example of a process for funding a mortgage in accordance with an embodiment of the present invention.

FIG. 7 shows an additional example of a process for funding a mortgage in accordance with an embodiment of the present invention.

FIG. 8 shows a comparison of the lifecycles of a bond and of a mortgage created in accordance with an embodiment of the present invention.

### DETAILED DESCRIPTION OF THE INVENTION

The present invention eliminates costs and headaches of refinancing debt instruments, such as mortgages, by providing a new financial product which automatically decreases the interest rates of the debt instrument when the prevailing interest rates for such instruments decline. This automatic decrease of the interest rate eliminates the incentive of a debtor, such as a mortgagor, to refinance when the prevailing interest rate declines. The financial product of the present invention also includes a bond which is expressly or implicitly linked to the debt instrument.

The financial product of the present invention is commercially feasible because the bond holder obtains a benefit from the new financial product, as well. The bond holder-earns income from the bond which is commensurate with the prevailing interest rate for a longer time because the debt instrument is not terminated due to a refinancing. As a result, the bond holder avoids the cost and expenses associated with the termination of a bond and with the selection and purchase of a new bond.

The financial product and method of the present invention is particularly useful in connection with mortgages used for financing real estate, especially in connection with mortgages which the mortgagee can refinance without incurring any penalties. When the interest rate of a mortgage falls sufficiently below the interest rate provided in the mortgage note, the mortgagor has an incentive to refinance the mortgage at a lower interest rate. However, much of the savings from obtaining a new mortgage with a lower interest rate are often consumed by the expenditures inherent in obtaining a new mortgage. In addition to the financial expenditure of obtaining a new mortgage, the mortgagor spends a considerable amount of time determining whether refinancing is financially beneficial, researching for the best deal, obtaining information needed for the new mortgage, completing extensive paperwork and attending the closing of the mortgage. Accordingly, a mortgage which automatically adjusts downward to reflect decreasing interest rates is beneficial to the mortgagor.

The mortgage-bond product of the present invention is commercially feasible because it also offers advantages to the bond holder. Since the mortgagor does not have an incentive to refinance because of lower prevailing interest rates, the bond holder can obtain interest on the bond for a longer time and avoid the transaction costs of obtaining a new bond when a refinancing takes place.

The financial product of the present invention offers a debt instrument or pool of debt instruments whose interest rate is adjusted down when the prevailing interest rates decline but whose interest rate, in the preferred embodiment, is never increased and a bond or a set of bonds which are expressly or implicitly linked to the debt instrument or pool of debt instruments. This financial product includes a debt instrument and a bond which is linked to the debt instrument. The debt instrument may include a provision for decreasing the interest rate on the outstanding debt in a predetermined manner when the level of a specified financial or non-financial index changes in a prespecified manner. The bond is linked to the debt instrument and provides for decreasing the interest rate paid on the bond in a preselected manner when the level of a specified index changes in a prespecified manner.

The financial product of the present invention can include any debt instrument including (for example) a mortgage note, a car loan, boat loan, recreational vehicle loan or student loan. These loan instruments can but need not be collateralized. The financial product of the present invention is particularly useful in connection with mortgages because it results in savings of costs, fees and taxes associated with the refinancing of mortgages, which are often significant. The debt instrument can be with or without a guarantee by the borrower or a third party or parties.

The financial product can include a pool of debt instruments in place of a debt instrument. For example, the pool might include several or many home mortgages of identical, similar, or even quite dissimilar interest rates and other terms, or a pool might consist of student loans or other types of loans with identical, similar, or even quite dissimilar terms. Dissimilar loans with quite dissimilar terms could be placed in a pool of notes funded by a bond or a set of bonds.

The financial product can include any bond which pays interest to its holder, expressly or implicitly. Mortgage-backed securities and asset-backed securities are examples of specific types of bonds. Bonds can but need not have some type of pass-through feature by which principal is repaid to the investor as principal is being repaid on the loan funded by said bonds. Bonds useful in connection with this invention can have equity-like features or attachments, such as they can be convertible into common stock, they can have stock warrants attached, profits can be shared between borrower and lender, or the bond investor can share in the price appreciation of an asset, such as under a shared-appreciation mortgage.

The financial product can be a single bond or it can include a bond issue (a set of bonds, with each bond having identical terms) or a series of bonds (often called serial bonds) in place of a single bond with each series of bonds incorporating different interest rates, repayment terms, maturity dates (or a single maturity date, in the case of “bullet” bonds where the entire principal is due on a single date), and other variables, such as exposure to credit losses experienced by the debt instruments linked to the bonds. The series of bonds may further be subdivided into a plurality of tranches. Each tranche can vary from other tranches in a number of ways including for example, interest rates, repayment rates or risks of non-repayment.

The link between the debt instrument and the bond can be contractually established by an agreement. For example, the link can be established by including provisions in both the debt instrument and the bond for decreasing the respective interest rates in a specified manner. The decrease in the interest rates for the debt instrument and for the bond can be based on the same index or on different indices. Similarly, the decrease in the interest rate on the bond can be the same as that in the debt instrument or the decrease for the debt instrument can be different from that for the bond. For example, the interest rate on the debt instrument may change for reasons other than a rate decrease, such as a change in the borrower's credit quality. In addition, the decrease in the interest rate for the debt instrument can be computed in the same manner as the decrease for the bond or they can be computed in a different manner. In addition, both the note and the bond could have a floor or minimum interest rate below which neither instrument could decline.

The note and the bond can each provide for interest rate adjustments independent of declines in the interest rates to which the two linked instruments are indexed. For example, periodically the interest-rate index or other interest-rate benchmark for either or both instruments could change to another pre-determined index or benchmark, such as a shorter-term security. Since there are not published interest-rate indexes for all possible maturities of notes and bonds to which rates might be indexed, the invention encompasses the use of an “extrapolation factor(s)” to adjust from a published index to the desired maturity of the note and/or bond.

If the debt instruments are securitized, the issuer of the financial product of the present invention can serve as the trustee or, in the alternative, an independent trustee can administer the securitized form of these financial products.

Hybrid mortgages, carrying a fixed rate of interest for a predetermined initial period of time before the rate could begin to decrease, could be funded with a bond or a set of bonds with a fixed interest rate for the same initial period as the mortgage before the rate on the bond or bonds would begin to decline. In this embodiment, principal repayments on the mortgages flow to the bond owners in the same manner as if there had been no initial fixed rate of interest.

The present invention includes financial products where an explicit contract to tie the interest rate of the debt instrument to the bond interest rate does not exist, such as a lease, an Islamic financing arrangement, or where there is not a clear-cut contractual linkage between the debt instrument interest and the bond interest, but there is a de facto relationship or linkage between the two. This de factor relationship can extend to situations where the debt instrument is originated by one party and then sold to an unrelated party, such as F&F, who then issues a bond, a set of bonds, or a series of bonds whose interest rated is linked, explicitly or implicitly, to the debt instruments.

Islamic financing bars the explicit payment of interest, or riba, on a loan. If money is lent, the principal must be repaid, without the additional explicit payment of riba. In Islamic-like financing transactions, the lender receives the equivalent of interest by agreeing to sell the asset being financed at a future date to a purchaser, in effect the borrower, at a price which is higher than what the asset can be purchased for at the time the transaction is arranged. The future date represents the termination of the lending arrangement and the price mark-up represents the equivalent of interest, or riba. One variation of Islamic finance is murabaha, or installment financing. As with other types of Islamic loans, the interest portion of the loan represents the mark-up on the cost of the property to the lender that is included in the purchase price for the property paid by the borrower through periodic payments. Land contracts and lease-to-own financing arrangements used occasionally in the United States and elsewhere to finance asset purchases are similar to murabaha. Common to all these arrangements is a guaranteed mark-up (the buyer/borrower's purchase price at a future date is established up front) which is the equivalent of interest. The principles of this invention could be applied in these situations through a contractual reduction in the future price of the asset, based on a predetermined interest-rate or other type of index. The assets could be funded with bonds linked to the asset price-reducing index.

Common to all these situations is a linkage or relationship, contractual, de facto, or otherwise, between two sets of cash flows, one on each side of the balance sheet. Whether a set of cash flows on the asset side of the balance sheet is called a loan, a lease receivable, or something comparable, those cash flows result from the existence of a financial claim on a third party.

A linked relationship (explicit or implicit) exists any time the interest rate incorporated in the receipt of one set of cash flows is linked, explicitly or implicitly, to the interest rate incorporated in the payment of a second set of cash flows such that when the interest rate for one set of cash flows adjusts downward (but never upward), in accordance with a change in a contractually identified index, the interest rate on the second set of cash flows adjusts downward (but never upward) in accordance with a change in a contractually identified index.

The adjustment of the interest rate or of the effective interest rate on the note can be effectuated based on any predetermined or preselected index, including (without limitation) one or more financial indices, one or more non-financial indices, commodity prices (such as gold), a swap rate, one or more derivatives of interest rates, or one or more interest rate indices.

In the alternative, the debt instrument interest rate adjustment can be tied to the bond interest rate adjustment. The bond interest rate can also be based on any predetermined or preselected index, including (without limitation) one or more financial indices, one or more non-financial indices, commodity prices (such as gold), a swap rate, one or more derivatives of interest rates, or one or more interest rate indices.

In the alternative, the bond interest rate adjustment can be tied to the debt instrument interest rate adjustment. Additionally, the bond interest rate adjustment can be based on the same index as the debt instrument interest rate adjustment or they can be based on different indices. In accordance with an embodiment of the present invention, the debt instrument interest rate and the bond interest rate can be adjusted to maintain substantially the same or the same interest rate spread between adjustments.

When, in accordance with one embodiment of the present invention, the debt instrument interest and the bond interest are properly linked or tied together, the financial product of the present invention becomes an extremely efficient financing tool because it is a perfect hedge when both are tied to same index, adjust at the same time, and have the same proportional amortization schedule or a nearly perfect hedge when tied to similar indices, adjusting at nearly the same time, and with nearly matched amortization schedules. Hedging the interest-rate risk associated with long-term, fixed-rate debt is a hugely expensive problem, and technically difficult to accomplish, as is evidenced by the enormous hedging costs and related accounting costs (implementing Financial Accounting Standards (FAS) 133 and 149) incurred by the American housing finance industry. Billions of dollars annually are spent on hedging. For example, Fannie Mae's forthcoming $10.8 billion (after-tax) financial restatement stems largely from its hedging activities and problems implementing FAS 133 and 149.

As used herein a “proportional amortization schedule” means that the same percentage of the original principal balance of each instrument is paid off in each period of the amortization time frame. That proportionality permits a pool of notes funded by a slightly smaller amount of bonds to maintain a constant sliver of equity capital in the pool to protect the bonds from note defaults. For example, a pool of $100 million of notes might be funded by $99 million of bonds and a $1 million equity capital cushion. The note principal and the bond principal would be paid down, on a pass-through basis, by the same percentage every month, which would permit the operator of the pool (e.g. the owner of the notes/issuer of the bonds) to withdraw the same percentage of equity each month from the pool. That is, all three financial components of the pool would be scheduled to shrink by the same percentage each month so as to maintain a constant proportional relationship between the three components. Note defaults would be absorbed by the equity cushion (the pool's shock absorber) so as to maintain the proportional shrinking of the remaining outstanding balance of notes and bonds. In other words, bonds can perfectly hedge the linked notes even through the initial amount of bonds is slightly less than the remaining principal balance of the notes, provided that each instrument has the same proportional amortization schedule.

The payments on the bond and the note can follow the current practice. For example, note debtors can either be sent a statement periodically or a coupon book and then they would mail in a check or money order periodically to the mortgage servicer or they would agree that the servicer could automatically debit their bank account periodically or arrange for the payment due on the note by other means, such as a wire transfer of funds. Bond owners can receive interest and a return of principal either by check, a credit to their bank account, or by other means, such as a wire transfer of funds or a credit to a brokerage account. Similarly, the bond payments can be accumulated and the note payments can be applied to reduce the bond principal and/or the interest due on the bond.

Although one important use of the present invention is a financial product which includes a link with a mortgage and a bond, the present invention is not limited to mortgage/bond financial products and encompasses a variety of debt instrument/bond financial products besides mortgage/bond products. Such financial products may or may not require collateral. The following are examples of various types of financial products:

(a) Loans to finance the purchase of cooperative apartments. The present invention can be used for financial products to finance cooperative apartments. This type of loan is comparable to a mortgage loan on a single-family home or condominium except that it is not secured by real estate, but instead by stock in the corporation which owns the cooperative building and instead of fee simple the owner receives a “proprietary lease” on the living unit in the building that the borrower will occupy.

(b) Timeshares. The present invention is applicable to financial products for the financing of “timeshare” interests in real estate or other tangible assets, such as a boat or mobile home. In a timeshare situation, two or more parties share the ownership of an asset, with each owner having the exclusive use of the asset for a predetermined period of time. Each party may or may not be permitted to lease its timeshare interest to another party or swap the period of exclusive use of that asset for another time period.

(c) Student loans. The present invention is applicable to financial products for financing post-graduation “consolidation” student loans; that is, the loan or loans into which graduates of colleges and professional schools consolidate the loans they took out as students. These consolidation loans carry a fixed interest rate and have amortization periods that can run for as long as 30 years. Currently, they are funded with short-term debt. These consolidated loans could be funded with long-term debt using the financial products of the present invention. This approach would free borrowers from being locked in for up to 30 years at an interest rate that, by law, can be as high as 8.25%. The present invention will work in this situation, even though consolidation student loans are not collateralized, because it is not necessary for the loans funded by bonds to be collateralized. Other types of uncollateralized loans, to individuals, businesses, and other types of organizations, such as non-profits and governments of all types, could be funded using financial products of the present invention. The federal government is a major lender to the U.S. economy, through scores of lending programs; conceivably even it could employ the financial product and method of the present invention.

(d) Step-up loans, negative amortization loans, balloon and bullet loans, partial interest-only loans, and reverse mortgages. The present invention can be applied to (1) “step-up loans” where the monthly payment in the initial months or years of the loan does not provide for a full amortization of the loan by its scheduled maturity date; that can be achieved only by a higher or stepped up monthly payment in the latter years of the loan; (2) “negative amortization loans,” a type of step-up loan where the monthly payment on the loan is less than the interest on it, with the difference being added to the loan principal for a later amortization or payoff; (3) “balloon loans” that mature before the principal is fully amortized and “bullet loans,” which essentially are interest-only or non-amortizing loans, with the entire amount of the principal not due until maturity; and (4) “partial interest-only loans” where only interest is paid during a portion of the term of the loan (usually in the initial years of the loan) where principal is fully or partially amortized during the remainder of the term of the loan; and (5) “reverse mortgages,” which enable people (usually retirees) to gradually tap the equity in their home through monthly payments they receive. Those payments, and the interest on the accumulated payments, build up the loan balance that is paid off from the proceeds of the sale of the home.

(e) Junior mortgages and debt otherwise subordinated. The present invention can be tailored for junior mortgages and other forms of indebtedness, secured or unsecured, which are junior in liquidation preference or otherwise in terms of repayment to more senior debt, such as first mortgages. For example, a second mortgage could be funded by a linked bond, a set of bonds, or a series of bonds which have terms and conditions that are independent of the terms and conditions applicable to a first mortgage linked to bond, set of bonds, or a series of bonds funding the first mortgage.

The above examples merely illustrate various types of loans with which the present invention can be employed. It should be understood that these examples are merely illustrative of the loan transactions to which the present invention can apply and are not meant to exclude other types of financial products, some of which may not yet exist.

The financial products of the present invention can (but need not) include one or more of the following features:

(a) Rate differential or loan spread covers. The difference between the interest rate on the note and the bond may cover some or all of these costs: note servicing, bond servicing, note credit losses, return on the equity capital utilized to fund the difference between the note principal balance and the bond principal balance, with that equity capital also serving as a loss-absorbing cushion to protect bond investors from note defaults. The present invention is applicable to systems and methods regardless as to whether costs are covered by or not covered by the interest-rate differential between the note and the bond.

(b) Smoothed Rate Adjustment. The note/bond rate reset process may be based on an average of the contractually specified index rate over a period of a few days, even a few weeks, or a few months. That smoothing would protect bond investors from unusual one-day or short-term plunges in the rate index to which the note and/or the bond can be linked. The marketplace will determine the desirability and the extent to which this rate smoothing occurs and the desirability of this feature. It is reasonable to assume that rate smoothing might emerge as such rate smoothing already exists for ARMs, such as the 11^{th} District Cost of Funds Index, published by the Federal Home Loan Bank of San Francisco.

(c) Credit Risk. The applicability of the present invention is not dependent on note credit risk. That is, a note can be funded by a bond no matter how high the credit risk of the note.

(d) A Bond Can Be a Perfect Hedge for a Note. Using the present invention allows a bond to be a perfect hedge for a note. This feature is very powerful and financially valuable, reflecting the synergy resulting from linking a note to a bond. For example, when the following conditions are satisfied, the perfect hedge feature is achieved: (1) the note and the bond are linked to the same index, (2) the note and bond adjust downward at the same time, and (3) the note and the bond have the same proportional amortization schedule; that is, principal and interest pass through to the bond as payments are made on the note. When these conditions are met, the following components of interest-rate risk are eliminated: maturity mismatching, basis risk, volatility risk, yield curve risk, and duration and convexity risk. This is an extremely valuable value-added of the invention, a synergistic value-added that does not exist separately for the note and the bond. An example of a particular case of a perfect hedge is when the bond or a set of bonds is a pass-through asset-backed security backed by a pool of notes.

(e) Discounts and premiums. The initial amount of a note or bond often is adjusted by an initial premium or discount (addition or subtraction) so as to alter the effective interest rate of the note or bond. For example, homeowners often pay discount points at the time they take out a mortgage so as to reduce the amount of interest they pay while the mortgage is outstanding. For accounting and financial reporting purposes, the amount of the discount or premium is amortized over the life of the note or bond to reflect the true interest rate on the note or bond.

(f) Origination fees and other charges. Oftentimes lenders will charge borrowers origination fees and other fees to cover the cost of making a loan (including a profit on the origination activity) in lieu of recovering those costs and profit through the interest rate on the note. This practice is particularly prevalent with home mortgages, but can occur with any type of loan or lease or other type of debt financing.

The present invention is applicable to a variety of financings, including (without limitation) mortgages, collateralized closed-end consumer loans, student loans and other types of non-collateralized consumer loans, loans to finance cooperative apartments secured by co-op stock and/or proprietary leases, commercial real estate financing secured by leases, sale-lease back financings, and fixed-rate equipment leasing and comparable financial structures which may not exist today, but which may be created in the future.

The present invention can be applied to any type of debt financing situation where there is a desire to closely tie a contractual reduction in the interest rate on a loan or other form of indebtedness to the contractual reduction in the interest rate paid on the debt-denominated capital financing that indebtedness. In the context of the United States, the present invention could apply to the debt financing of any type of real estate or even to non-real estate debt financing and whether that financing is collateralized or not and whether that financing is personally guaranteed by the borrower or a third party or parties. While the present invention is most commercially advantageous in situations where the borrower is not subject to a prepayment penalty when refinancing, it also is applicable to financial instruments which do provide for a pre-payment penalty. Experience may show, though, that linking a borrowing to the funding for that borrowing may be more efficient in some cases than charging a prepayment penalty.

More broadly, the present invention could be utilized outside the United States for the same purposes, specifically in countries with well-developed financial markets. Many European countries, where homes often are financed with mortgages funded by mortgage bonds, are particularly good candidates for the application of the present invention.

The present invention can also be utilized where the financing involves two or more currencies. For example, as already occurs in U.S. mortgage finance, the debt instrument could be denominated in U.S. dollars while the bond could be denominated in a second currency, such as the Euro or the British pound, or in a basket of currencies. The foreign-currency portion of the explicitly or implicitly linked relationship between the note and the bond could be hedged in the same or different manner as foreign-exchange risks are hedged today while the interest rate paid on the two instruments could be linked in the manner described by the present invention.

The system and method of the present invention can be implemented by computers; and the method is preferably fully automated. It is well known in the art how to write a computer instruction code to implement all steps of the various alternative embodiments of the present invention.

The system of the present invention can be fully automated. The system preferably includes a computer which has a CPU and associated execution programs, storage for the program, instruction code and data. The storage can include ROM, RAM, flash memory, hard drives, magnetic storage medium or any other device or medium which stores programs, data and/or computer code. The computer can be connected to a network, such as, an internal network, the Internet, an internet or an intranet. The computer can be programmed to obtain external information which is required for operating the system of the present invention. In the alternative, the external information can be inputted into the computer through a connection, by a keyboard, using a disc, such as a CD or a DVD, using a flash memory stick or using any other input device or medium. External information which the computer either obtains or receives is, for example, an index or indices which based on the terms of the financial product determine whether the interest rate on the bond and/or the debt instrument needs to be adjusted.

Any input device or input media can also be used to input into the computer a code containing the terms of the financial product, such as for example, the manner in which the note rate is adjusted, the manner in which the bond rate is adjusted and the events which trigger the adjustments.

The code can include instructions to send notices in an electronic form to a printer connected to the computer system, which upon being printed can then be mailed to the debtors and the bond holders. In the alternative, the computer can be connected to a network, an internet, the Internet or an intranet to send notices in an electronic form, such as, for example as emails or email attachments.

Any suitable computer program can be used to execute the code for carrying out the present invention. Such programs can be stored in the computer, in a ROM, RAM, flash memory, or any other medium or device or it can be stored in a server or any other device or medium outside the computer connected in some fashion to the computer. Similarly, the data and the instruction code can be stored in a ROM, RAM, flash memory or any other medium or device and can also can be stored on a server or any other device or medium outside the computer connected in some fashion to the computer.

Of course, some or all of the tasks can be performed without the use of a computer. The embodiment of the system and method of the present invention which are not fully automated or not automated at all are within the scope of the present invention.

It should be noted that computer implementation of the present invention is particularly beneficial when the financial product includes a large number of bonds and debt instruments, especially if such bonds and debt instruments are not identical.

As used herein, the term “connection” includes any connection, including a wireless connection, a broad band connection, or a telephone connection. The connection may be established by modem or by any other system or device.

### DESCRIPTION OF THE PREFERRED EMBODIMENTS

In a preferred embodiment of the present invention, a mortgage note is linked to a bond. Since the mortgage is adjusted only one way (i.e., down), a descriptive term for this arrangement is a ratchet mortgage (RM). Similarly, since the bond is adjusted only one way (i.e., down), a ratchet bond (RB) describes this arrangement. In the alternative, an RM can be linked to a different type of bond, called a ratchet pass-through (RPT), or the RM can be linked to a combination of RBs and RPTs. In a preferred embodiment, RBs and RPTs can be viewed as funding instruments for RMs. The financial markets will determine the mix of RBs and RPTs used to fund RMs. Following a description of the preferred embodiments of an RM will be a description of the preferred embodiments of the RPT and the RB.

### Description of the Preferred Embodiments Of a Ratchet Mortgage

RMs automate and optimize the mortgage refinance option in an essentially costless manner while leaving in place the turnover option, the right to pay off a note early, with or without penalty. Rather than replacing the existing mortgage with a new mortgage, which incurs multiple costs and disruptions, the interest rate on the RM is simply reset in accordance with a contractually referenced interest-rate index, such as the yield on the ten-year Treasury note, the ten-year swap rate, the Constant Maturity Mortgage swap rate, or a similar widely published interest rate or even a non-published interest-rate index. However, unlike ARMs, where the interest rate can go up or down, the rate on an RM of the preferred embodiment can only go down. That is, if the index signals a lower interest rate, the rate on the RM will decline by the contractually specified amount. Generally, but not necessarily, the RM rate will decrease by the same amount as the decline in the index. However, if the index then signals a higher interest rate, the rate on the RM will not increase. The bar on interest-rate increases over the life of an RM, which can have an original maturity of thirty years or more, is a very powerful feature because (1) the RM protects the borrower against interest rate increases, (2) the RM enables lenders and investors to put capital to work for longer periods of time (the average life of an RM could be eight to ten years, or more), and (3) the RM eliminates refinancing costs when the sole objective of the refinance is to lower the mortgage interest rate.

The RM interest rate reset process is fully automated and unconditional. That is, the interest rate on all RMs which are tied to a certain index decreases, as contractually provided, if the index declines regardless of the creditworthiness of the individual borrowers. Each homeowner/borrower simply receives a notice as to what the new interest rate and monthly payment will be. There is no need to incur any other costs because a new mortgage is not originated.

RMs provide for great flexibility in resetting interest rates. For example, any one of a wide variety of rate indices may be selected. It is preferred, but not necessary, to select a published index to minimize disputes as to when the index changed and by how much. The frequency of the mortgage repricing and the amount of the rate reset also may vary. For example, the mortgage could carry an initial “rate lock” of a few months or a few years, which would bar a rate reset until after the end of the rate-lock period. The RM also could provide that the rate could only decrease once or twice a year or only after a certain time lapse since the last rate reset. Also, it could provide that a rate reset would not occur unless the index rate had declined by a certain amount, such as ten, twenty-five, or fifty basis points (one basis point equals 0.01%). The RM could even provide for various combinations of these indexing features.

The rate-reduction feature of the present invention is different from an “automatic rate reduction” loan, which actually entails the origination of a new FRM to replace an FRM carrying the higher rate. That is, instead of the rate actually being reduced on the initial mortgage, as is the case with the present invention, a new FRM is underwritten at a lower rate to replace the previous FRM that carried the higher rate. One indication that this happens is the fact that some fees are charged when the rate is reduced on an “automatic rate reduction” mortgage loan. The RM component of the present invention has no fees associated with rate reductions because the rate reduction incurs no transaction costs.

RMs provide interest-rate protection that ARMs do not because the rate on an RM, in the preferred embodiments, can never increase. While annual and lifetime limits usually cap or limit the maximum rate increase on an ARM over its life to 5% or 6%, that still represents a substantial threat to homeowners because a rate increase will cause a higher monthly mortgage payment. For example, if the rate on an ARM rose over three years from 4% when it was originated to a lifetime cap or ceiling of 10% (4% initial rate plus a 6% maximum lifetime rate increase), the monthly payment on the mortgage would rise 80%. Fearing the threat of higher monthly payments, many homeowners who take out ARMs later shift to FRMs as long-term mortgage interest rates decline or as the “yield curve” (the relationship of short-term interest rates to long-term rates) flattens. Hence, ARMs are properly viewed as short-term home financing or transition financing until an FRM can be secured at a reasonable rate.

The opportunity to increase the amount of a first mortgage, known as an “equity cash-out” or “cash-out refinancing” is one motivating factor driving mortgage refinancing. That is, the homeowner increases the amount borrowed while gaining a lower interest rate. Home equity loans and “home equity lines of credit” (HELOCs), which are second or junior mortgages, provide another avenue for cashing out equity in a home. RMs can provide a similar equity cash-out opportunity, either when the mortgage interest-rate decreases or at other times. At rate reset time, the lender can increase the mortgage balance at close to the par value of the additional amount borrowed. That is, the amount of cash the homeowner receives might be slightly higher or slightly lower than the amount of increase in the mortgage balance. In bond market terms, this differential is called a premium or a discount. The amount of the premium or discount will depend upon the interest-rate differential between the interest-rate paid on the RPT or RB funding the RM and current RPT or RB interest rates and the remaining life or term of the mortgage.

The cash-out premium or discount may be greater if the mortgage balance is increased at a time other than when the interest rate decreases. This is because the interest-rate differential between the rate on newly issued RPTs or RBs and the rate applied to the outstanding RPTs or RBs is higher than the reset value of the RM. This is particularly true should interest rates rise significantly above the rate on the RM. For example, if the RM carries a 6% rate but new RMs carry a 7% rate, the homeowner wants to borrow another $50,000, and the remaining term of the mortgage is twenty-four years, the mortgage balance will have to rise by $54,709 in order for the homeowner to borrow that $50,000.

The RPT or RB may provide that borrowing an additional amount under an existing RM may cause the final maturity date of the RM to be extended to a future date sufficient to restore the amortization period for the principal of the RM to what it was when it was first originated. The final maturity date of the RB would correspondingly be extended while the pass-through for the RPT would be conformed with the RM's new maturity date. For example, if an additional amount is borrowed at the beginning of the fourth year of a 30-year RM funded by a 30-year RB, the maturity date of the RM and the RB might be extended three years so that the amortization period of the RM and the RB is again a 30-year period. Alternatively, the additional borrowing under the RM, and the linked RPT or RB providing the funds for that additional borrowing, may carry a different interest rate, under predetermined terms and conditions, with the borrower then paying a “blended” rate of interest, reflecting the interest cost of the initial and additional borrowing and the linked RBs or RPTs paying a similarly blended rate of interest.

Borrowing an additional amount under an existing RM would incur additional costs, but these costs are small in comparison to the transaction fees associated with refinancing FRMs. This is because borrowing an additional amount under an existing RM does not require replacement of the mortgage instrument, the recording of a new lien on the mortgaged property or other collateral, new title insurance, or additional legal fees. Rather, costs are limited to updated home appraisals and updated credit reports and other expenses a lender may incur to increase the loan amount even though a new mortgage instrument is not created nor new lien documents filed with the local government recorder of deeds and liens.

Increasing the amount of a mortgage after origination may create problems in obtaining subsequent junior mortgages secured by the property, such as a HELOC. The junior lender may be concerned that the amount of equity securing the loan is insufficient if an additional amount is borrowed under the RM. In particular, the amount owed under the second mortgage plus the increased balance on the RM might exceed the maximum loan-to-value (LTV) ratio permitted by the second mortgage lender. To protect against this possibility, second mortgage lenders could be reluctant to lend if the balance owed on the first mortgage with the ratcheting feature could be increased at a subsequent date. That reluctance could sharply diminish interest in RMs which permit additional borrowing under the RM while it is outstanding, which in turn would reduce the appeal of the RM vis-a-vis the mortgage refinance option. However, this concern of junior lenders can be overcome by a provision in the ratcheting first mortgage that the additional amount borrowed under the first mortgage cannot push the combined LTV of the junior and senior mortgages above the LTV limit of the second mortgage lender.

### Description of the Preferred Embodiments Of a Ratchet Pass-Through

An RPT, in the preferred embodiments, represents one way to fund an RM. An RPT, as a “pass-through” financing instrument, would have the same fundamental characteristics as pass-through financing instruments generally. One key characteristic of a pass-through instrument is that it passes all prepayment risk from the instrument's issuer to the purchasers of the pass-through instrument. In the case of RPTs funding RMs, RM principal payments made by borrowers would be passed through or paid to RPT investors in the same proportion as the original amount of RPTs was to the original amount of the RMs. The payment of principal to the RPT investors would be made shortly after the RM principal was paid, usually within a month.

According to the present invention, RMs may be linked to and funded by RPTs with parallel term and interest-rate ratcheting features. For example, a pool of thirty-year RMs with an average initial interest rate of 5.80% might be funded with a pool of RPTs with an initial interest rate of 5.50%, producing a spread of thirty basis points to cover loan servicing expenses, credit losses, and a return on the equity capital differential between the principal balance on the mortgages and the principal balance on the bonds. Preferably, RMs and the RPTs are tied to the same interest-rate index, such as the ten-year Treasury note index. By being tied to the same rate index, as the interest rate on the RMs decreases, the interest rate on the RPTs ratchets down by the same number of basis points, thereby maintaining a constant thirty basis point lending spread.

As is the case today with fixed-rate mortgages, the mortgagor under an RM would have the option of accelerating the paydown of the mortgage or prepaying it at any time. Under the pass-through feature of RPTs, those principal repayments would flow through to the owners of the RPTs funding those mortgages, with very little delay. This pass-through would ensure that the remaining principal balance on the outstanding RMs at all times equals or slightly exceeds the remaining principal balance on the RPTs. Any differential between the two balances would represent the equity capital cushion the owner of the mortgages provided to the bond holders to give a high degree of protection against bond default arising from mortgage default.

All other things being equal, an RPT funding an RM will be more attractive to an investor than MBS funding FRMs because for RMs the relationship between interest-rate changes and cash flows to investors is specified in the RM and RPT contracts rather than determined by the refinancing whims of homeowners. That is, since the RM interest rate will decrease automatically, that automaticity will eliminate virtually all interest rate-driven refinancings, leaving only prepayments due to normal, and more predictable, mortgage turnover—sale of the home or other non-interest-rate-driven mortgage payoffs. The elimination of interest-rate-driven refinancings will enable RPT investors to use deterministic prepayment models to predict mortgage turnover, which in turn means that investors can value RPTs more systematically and accurately than they can value MBS used to fund FRMs.

While seemingly similar, the present invention, specifically the use of RPTs to fund RMs, differs greatly from securitized ARMs, sometimes called ARM MBS. The securitization of ARMs effectively ties the interest rate paid on the variable-rate securities funding a pool of securitized ARMs to the interest-rate index used to periodically reset the interest rate on the ARMs. However, the downward ratcheting of an RM funded by an RPT transforms the character of both the mortgage and the bond financing the mortgage by extending the average life of both instruments many years longer than the effective life of an ARM and the variable-rate securities funding the ARM. That is, the ARM represents short-term financing, because of frequent rate resets, up and down, typically on an annual basis, even though the principal of the mortgage is being amortized over a longer period, usually thirty years. In effect, an ARM is the equivalent of a short-term loan that periodically is renewed, without qualification, at a different interest rate (higher or lower) and with a somewhat smaller principal balance if there is ongoing principal amortization. The same is essentially true for the variable-rate securities funding the securitized pool of ARMs.

ARM interest rates generally are indexed to short-term rate indices, such as the One Year Constant Maturity Treasury (CMT) index, the London Interbank Offered Rate (LIBOR), or a Cost of Funds Index (COFI). In sharp contrast, as noted above, RMs, and therefore RPTs, will likely be indexed to securities with much longer maturities. This difference in maturities is another feature which greatly differentiates RMs funded by RPTs from securitized ARMs.

Not only will RMs funded with RPTs create a mortgage financing arrangement of a much longer life, on average, than securitized ARMs, but this arrangement will have a longer average life than even FRMs funded with MBS given that interest-rate driven refinancing of FRMs greatly shortens the average life of FRMs and the MBS financing those FRMs.

### Description of the Preferred Embodiments of a Ratchet Bond

An RB represents a second way, in the preferred embodiments, in which to fund an RM. In its simplest structure, a pool of RMs is funded by an undifferentiated set, or tranche, of RBs. That is, each bond is paid interest and repaid its principal on the same pre-determined schedule. However, a multi-tranche bond structure can be constructed such that some classes of RBs are paid down at an accelerated rate or, alternatively, have their principal payments deferred until other classes of the bonds are fully paid. Likewise, different tranches of bonds can be tied to different interest-rate indices. Mortgage originators will use RBs, instead of RPTs, to fund RMs when it is cheaper to do so. That lower cost can occur because some investors are willing to accept a lower interest rate in return for a bond's predictable stream of interest and principal payments.

Unlike RPTs, an RB issuer retains all RM prepayment risk. To minimize this risk, the issuer will structure RB maturities that are matched as closely as possible to the expected principal repayments of a pool of RMs funded by a pool of RBs. Repayments consist of the normal, scheduled amortization of RM principal plus prepayments due to the sale of the mortgaged home and mortgage payoffs for non-interest-rate-driven reasons, such as a divorce settlement. However, the RB issuer must actively manage the unexpected RM prepayments; that is, the difference between the prepayments the issuer predicted when it issued the RBs and the subsequent prepayment experience. Active management encompasses using interest-rate derivatives and other hedging devices to neutralize the cash-flow impact of unexpected prepayments on the issuer's earnings and equity capital. The automatic, contractual ratcheting down of the RM's interest rate eliminates the greatest factor causing unexpected mortgage prepayments—interest rate-driven prepayments due to mortgage refinancings. Using the same index for both the RMs and the linked RBs further reduces the issuer's cash-flow uncertainties.

While not a simple task, managing unexpected RM prepayments, when those RMs are funded by RBs, is easier and much less costly than managing unexpected FRM prepayments when those FRMs are funded by a mix of callable and non-callable debentures, as is the case at Fannie Mae and Freddie Mac. Neutralizing the impact of unexpected FRM prepayments requires a more extensive use of hedging devices, which are not cost-free. Fannie's and Freddie's widely reported financial troubles stem largely from the challenge of managing the financial risk associated with unpredicted, interest rate-driven FRM refinancings. Using RBs to fund RMs largely eliminates this challenge, and the associated costs, which now get passed through to homeowners, in the form of higher FRM interest rates.

While the yield on RBs will decline when rates go down, the mortgages financed by the RBs generally will pay off only as people sell their homes or restructure their finances for reasons not related to a drop in interest rates. Therefore, as is the case with RPTs, RBs will have a longer average life than debt instruments funding FRMs today, such as MBS and callable debt issued by Fannie Mae and Freddie Mac. That makes RBs funding RMs debt instruments which will appeal to “buy-and-hold” investors seeking longer-term investments with pre-specified repayment schedules.

An alternative to funding RMs with RBs is a variant of Canadian mortgage bonds, which are similar to American “bullet” bonds. Bullet bonds, such as U.S. Treasury bonds and notes, have no principal amortization during the lifetime of the bonds. Rather, the entire principal amount of the bond is repaid at maturity. Mortgage principal amortization, accelerated principal repayments, and mortgage payoffs are placed in a sinking fund held by the mortgage owner or trustee, and the proceeds are invested in safe assets until the bonds mature. Alternatively still, the RB principal may be repaid on a scheduled basis according to the scheduled amortization of the mortgages funded by the bonds. Mortgage prepayments and payoffs are held in a sinking fund and then paid out according to the scheduled amortization of the bond.

### Advantages of the Preferred Embodiments

By eliminating transaction costs and the time associated with refinancing FRMs, the present invention could save $10 billion or more annually in the financing of American homes. These savings would benefit various classes, including homeowners, bond investors, financial intermediaries, and mortgage lenders.

Homeowners will directly benefit from the present invention in at least two ways. First, due to likely lower loan origination costs of an RM compared to an FRM, homeowners will save when the purchase of a home is financed by an RM. Presently, most FRMs are sold in the secondary market, primarily to be purchased or guaranteed by Fannie Mae or Freddie Mac. It is well known that it costs more to originate a mortgage for sale in the secondary market than is the case if the mortgage is originated with the belief that it will not be sold later. For example, each mortgage sold into the secondary market has to carry title insurance and have the backing of a full appraisal. A mortgage originator desiring to retain ownership of the mortgage, which will often be the case with RMs funded by RPTs or RBs, may be willing to retain ownership of mortgages without individual title insurance policies (a group title insurance policy or self-insurance may be sufficient) and may be able to justify making a mortgage loan with a more limited, cheaper appraisal.

The far greater savings for the homeowner arises through the elimination of a subsequent refinancing of the purchase mortgage. Today, the refinance mortgage must be underwritten and documented to essentially the same extent as the purchase mortgage or an earlier refinance mortgage. The refinance origination cost can easily exceed several thousand dollars and is incurred even if the previous mortgage has been outstanding for just a year or two. The refinancing costs effectively add to the mortgage interest rate if those costs are amortized over the actual time the mortgage is outstanding. For example, if a homebuyer takes out a 6%, 30-year, $100,000 FRM, pays $2,000 in origination costs, and then refinances that mortgage three years later, the amortization of the $2,000 origination cost over the actual three-year life of the FRM effectively raises the interest rate on that mortgage to an “all-in” rate of 6.74%, or 74 basis points higher than the stated mortgage rate of 6%. On the other hand, if the homebuyer takes out a 30-year, $100,000 RM at 6% with $2,000 in origination costs and keeps that RM until he sells the home ten years later, the amortization of the $2,000 origination cost will add only 28 basis points to the stated mortgage rate, for an interest-rate reduction of 46 basis points (74−28). At the same time, the RM borrower will enjoy, without any cost and always at optimal times, all automatic rate reductions due to the downwardly indexing interest rate feature of the RM.

Because the interest rate on a RM will ratchet down automatically, and without any party incurring any cost, the RM effectively provides costless mortgage refinancing. The savings to homeowners arising from automatic, no-cost refinancing will lead to billions of dollars in annual savings. This great benefit is due to the contractual or de facto linkage of the RM with either an RB or an RPT; this benefit is maximized when an RM is funded by an RPT. The potential cost savings for borrowers of an RM versus an FRM that is periodically refinanced is comparable to the cost savings investors in an index mutual fund enjoy relative to the cost of an actively managed mutual fund.

Bond investors will save in several ways through widespread use of the present invention by owning RBs or RPTs instead of investing in callable debt or MBS funding FRMs. One costly aspect of owing MBS or callable debt is trying to predict FRM prepayment patterns due to interest-rate-driven refinancings (as differentiated from mortgage prepayments for other reasons, such as selling the home). Investment banking firms and institutional investors spend substantial sums on analytical tools and personnel to calculate prepayment risk so that they can properly value callable bonds and MBS when investing in those debt instruments. Reinvestment risk, specifically reinvesting mortgage prepayments, also is quite high and expensive to manage because of the idiosyncratic manner in which homeowners make refinancing decisions. RMs substantially reduce prepayment risk by automatically adjusting downward the mortgage interest rate as interest rates generally decline. Instead of homeowners individually deciding when to refinance, market forces will automatically dictate when the interest rate should drop on a pool of RMs, and on the RBs and/or RPTs funding those RMs. At the same time, this automatic mortgage repricing eliminates the administrative expense of reinvesting mortgage prepayments.

Banks, thrifts, and other types of mortgage originators could trim their operating expenses in several ways, too, through the widespread adoption of the present invention. First, total mortgage origination costs would drop substantially since interest rate-driven mortgage refinancing activity would largely disappear. Further, the remaining mortgage origination activity for purchase mortgages and the occasional refinance would be much more stable. Today, the sharp volatility in mortgage refinance activity forces mortgage originators to increase staffs during refinance booms and then to trim back, hopefully before experiencing operating losses, when the refinance boom ends. Financial intermediaries also will be able to build more durable customer relationships by retaining their mortgage borrowers as long-term customers. Today, a customer relationship often evaporates when the customer refinances a home mortgage with another financial firm. The intermediary's investment in building that relationship evaporates, too. This is true not only for the mortgage originator, but also for other intermediaries, such as mortgage insurers.

Mortgage servicing efficiency is impaired by frequent mortgage refinancing because of the one-time cost of making servicing arrangements for new mortgages while closing out the servicing arrangement for mortgages which have been refinanced. Additionally, the ownership of mortgage servicing rights (MSR) requires very expensive hedging programs due to the uncertainty as to when MSRs will evaporate due to mortgage refinancings. In effect, RMs funded by RBs or RPTs will bring much greater stability, and efficiency, to the mortgage servicing process.

Finally, the present invention is ripe for today's market. There are as many as fifty million single-family home mortgages outstanding in the United States today, perhaps as many as 60%, or thirty million, of which are FRMs. FRMs are the primary candidates to become RMs funded by RBs or RPTs as homes are purchased and FRMs are refinanced into RMs. For example, if one in five FRMs today eventually became an RM, there would be six million outstanding RMs. Assuming an average loan balance of $150,000, there would be $900 billion of RMs outstanding (11% of the total single-family mortgage debt outstanding in late 2005) funded by nearly that amount of RBs or RPTs.

The present invention will now be described more fully with reference to the Figures in which one preferred embodiment of the present invention is shown. The subject matter of this disclosure may, however, be embodied in many different forms and should not be construed as being limited to the preferred embodiment shown in the Figures or preferred embodiments described herein.

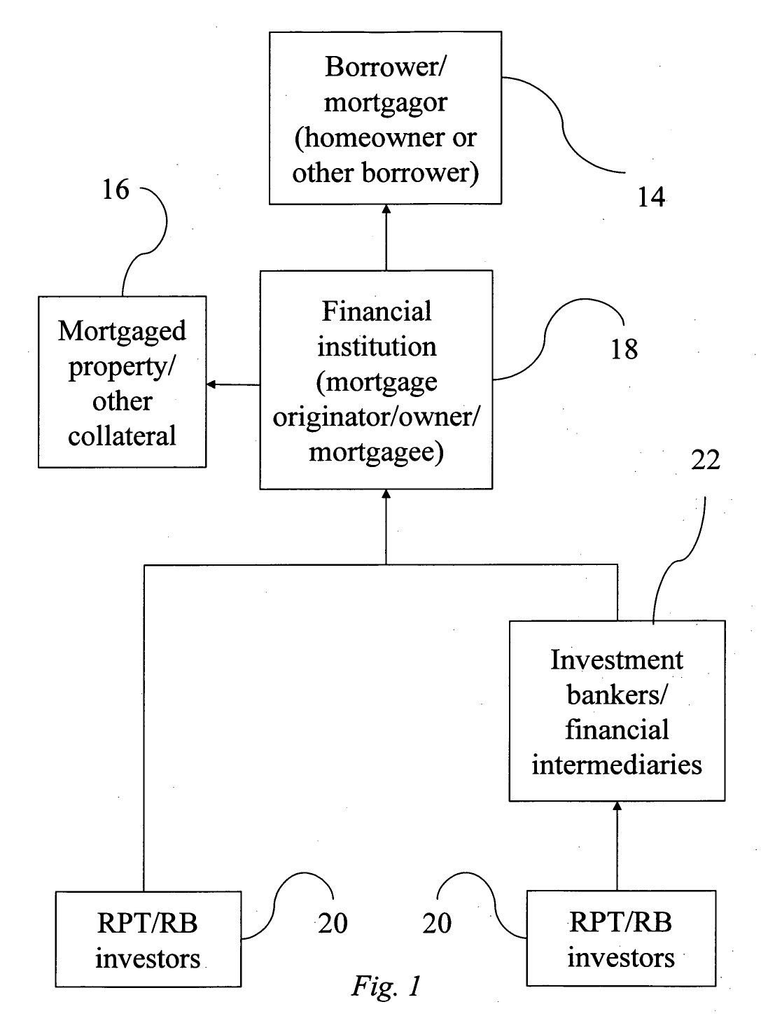

FIG. 1 illustrates the origination of an RM for a home mortgage and the financing of that RM with an RPT and/or RB. However, the business method illustrated in this figure would apply to any type of collateralized debt obligation.

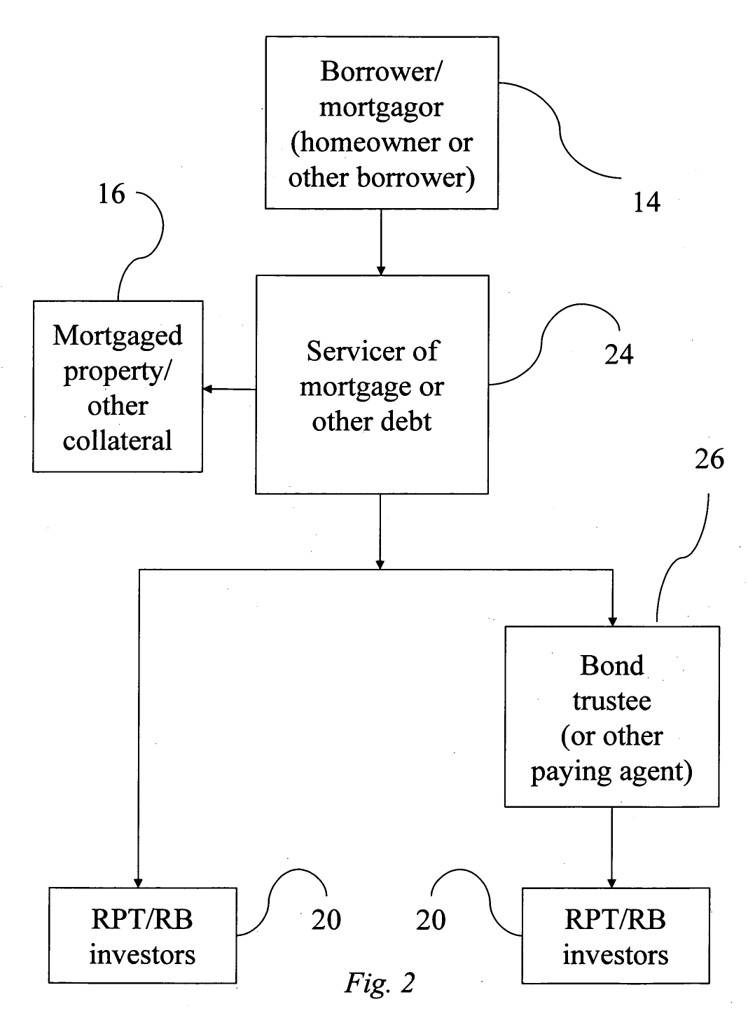

FIG. 2 is a variant of and complement to FIG. 1 as it shows how the RM or any similar collateralized loan would be serviced; that is, the principal and interest on the loan would be collected from the borrower and then forwarded (after deducting administrative and other costs associated with the loan) to RPT and/or RB investors.

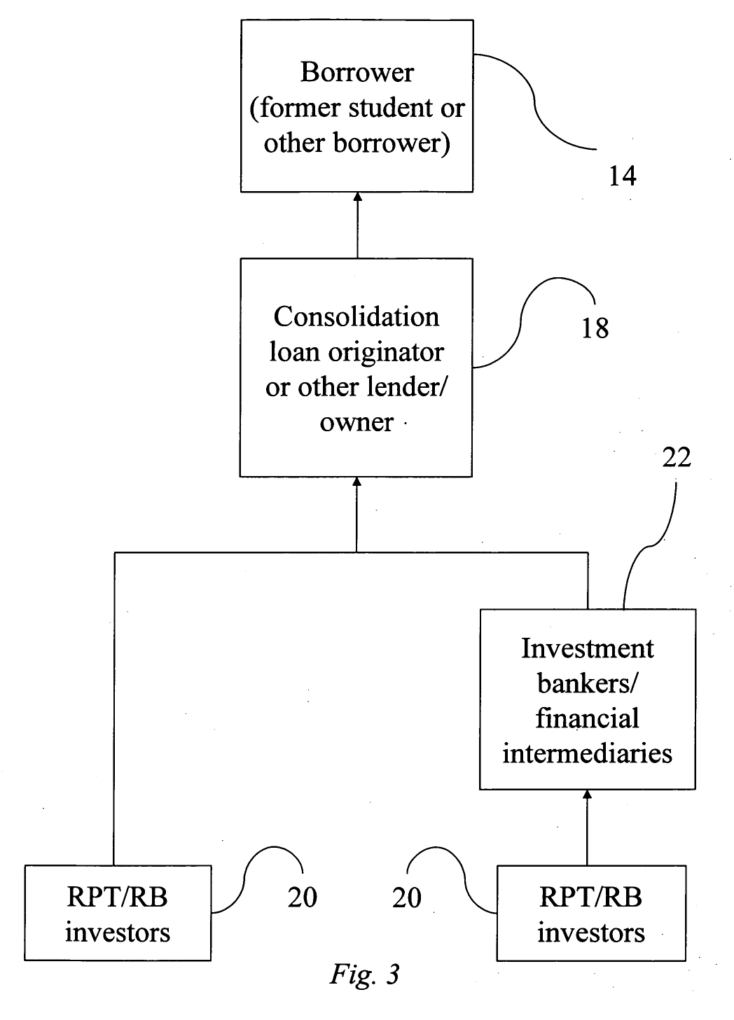

FIG. 3 is a variant of FIG. 1 to illustrate the utilization of the RM/RB invention when there is no loan collateral. A student loan post-graduation “consolidation loan” is used to illustrate the non-collateralized linkage of an RM with an RPT and/or RB, but the RM/RB invention can be utilized in this fashion with any type of non-collateralized lending.

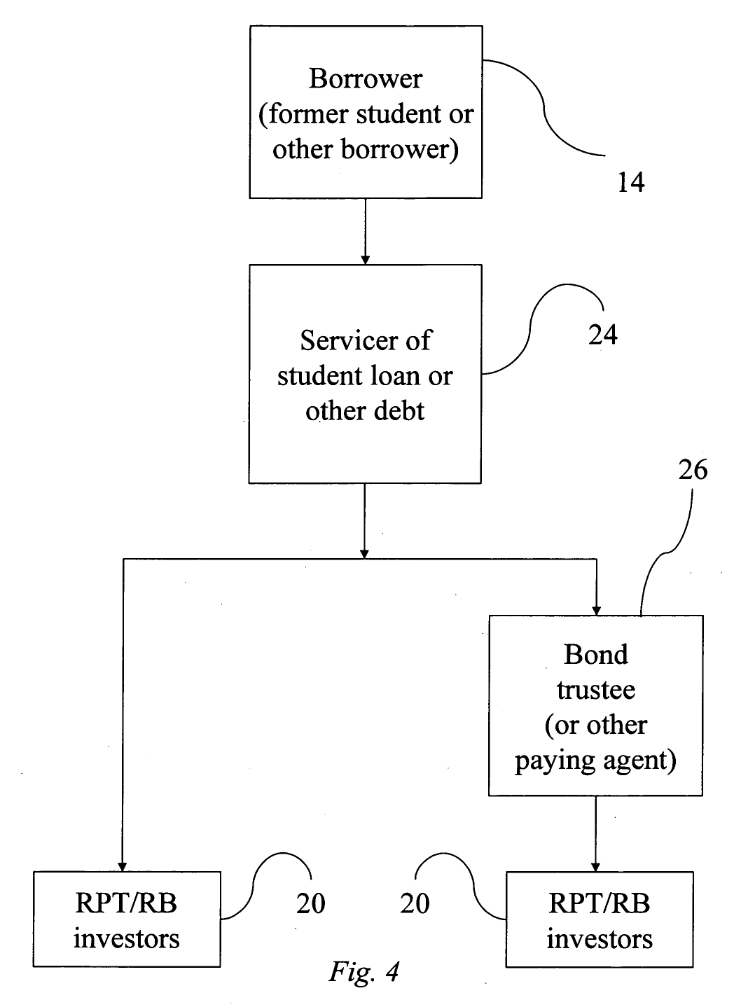

FIG. 4 is a variant of FIG. 2 and a complement to FIG. 3. This figure shows how the student loan or any similar noncollateralized loan would be serviced; that is, principal and interest on the loan would be collected from borrowers and then forwarded (after deducting administrative and other costs associated with the loan) to RPT and/or RB investors.

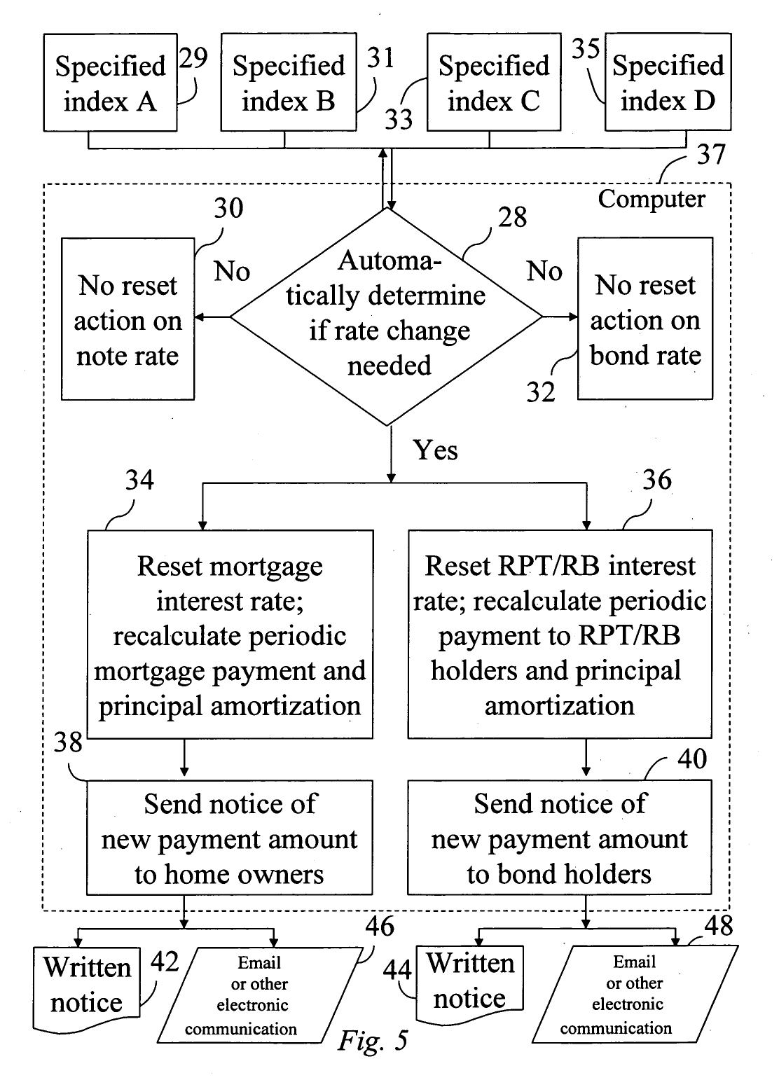

FIG. 5 illustrates options as to when a downward rate adjustment would be triggered: the mortgage interest rate change is triggered, which triggers a change in the bond interest rate; the bond rate change is triggered, which triggers a change in the mortgage rate; the mortgage and bond rate changes are triggered simultaneously by the same or different indices.

The system schematically depicted in FIG. 1 is an example of a fully automated, computer-implemented embodiment of the present invention. A computer is programmed with a code to carry out the steps of the method of the present invention. Specifically, these key features of the financial product are input into the computer. The key features include the terms of the bond and the note, the initial interest rate for the bond and the note, the index or indexes which determine changes in the note interest rate and in the bond interest rate, and the manner for determining whether the interest rate on the note and the interest rate on the bond should be changed. The code also includes a program for generating payment amortization and other schedules and for generating printed (written notices), as well as for generating emails and electronic communications to notify the bond holder and the debtor of changes in the interest rates on the bond and the note.

In operation, the computer periodically and automatically contacts web sites or other data sources which contain index or indexes which are specified in the note and the bond to determine changes in the interest rate on the bond and on the note. Either a single specified index such as index A (29) can be contacted or a combination of indexes, such as, indexes A, B, C and D (29, 31, 33, 35) in FIG. 5 can periodically be contacted by the computer, preferably via an Internet connection.

In the alternative, the system can be set up to receive periodic notifications from web sites or other data sources which have interest rates specified in the bond and in the note as the basis for adjusting the interest rates. Once the specified interest rate is received by the computer 37, the computer automatically determines whether the interest rate or the specified index or indices requires changing the note and the bond interest rates as indicated by numeral 28 in FIG. 5. If the interest rate need not be changed, no further action is taken by the system as indicated by 30, 32. If the computer determines that the specific index or indices requires adjustment of the note interest rate and/or the bond interest rate, the computer 37 generates a new interest rate for the mortgage note and recalculates the periodic mortgage payments and principal amortization schedule as indicated by 34. The computer 37 also resets the interest rate for the bond, recalculates the periodic payment to the bond investors, and recalculates the amortization of the bond principal as indicated by 36. The computer then sends electronic notices to both the homeowner and the bond investors notifying them of the reset rates and the new payment amounts as indicated by 38, 40. The computer can generate written printed notices 42, 44, which can then be mailed to homeowners and bond investors and/or electronic notices 44, 48 which can be sent via Internet or other electronic media to the bond investors and the homeowners.

The same procedure is repeated periodically as specified in the instruments of the financial product and input into the computer.

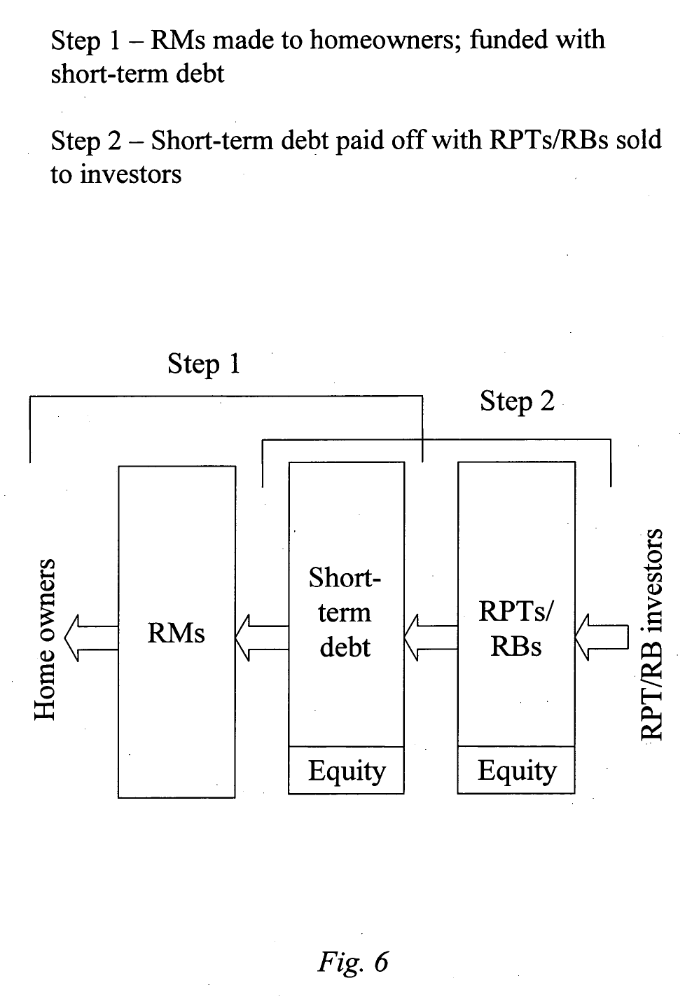

FIG. 6 illustrates one of two alternatives as to how RMs would be funded in a two-step process. Step 1 shows that mortgages would be funded by short-term debt as they were closed and then, in Step 2, after the mortgage owner has accumulated a sufficient number of mortgages, it would sell a sufficient amount of RPTs and/or RBs to pay off that short-term debt.

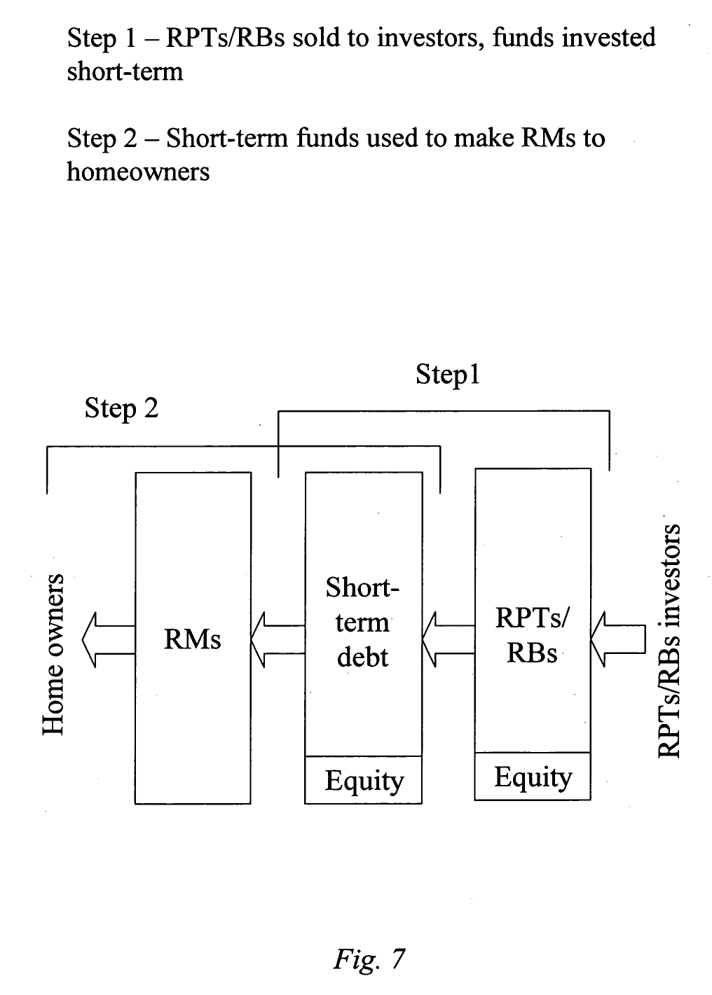

FIG. 7, a variant of FIG. 6, shows the reverse situation—a mortgage originator arranges long-term funding, Step 1, by selling RPTs and/or RBs and then invests those funds in short-term securities until those funds, along with any on-balance-sheet equity capital, are lent out as RMs, Step 2. It may be possible (but is unlikely) to combine the two steps, as shown in both FIG. 6 and FIG. 7, with the funds raised with RPTs and/or RBs being disbursed the same day to fund RMs collateralized by home mortgages, but that simultaneity could occur with large commercial loans.

FIG. 6 and FIG. 7 illustrate another aspect of the invention, the role of equity capital or some other type of loss cushion (such as subordinated debt, credit insurance, third-party guarantees, loan buy-back requirements, etc.) that will protect owners of RPTs and/or RBs from RM defaults and losses. Consequently, for a given pool of RMs, the amount of RPTs and/or RBs funding that pool will be (1) slightly less than the amount of RMs, with the difference made up by some sort of “on-balance-sheet” equity cushion (as illustrated in FIG. 6 and FIG. 7) or (2) if the amount of RPTs and/or RBs equals the amount of RMs, there will be some sort of express or implicit third-party guarantee standing behind the RPTs and RBs.

With reference to FIG. 1, there are four parties involved with the steps of the present invention. First, the borrower 14, also known as the buyer or homeowner, grants a mortgage on a home, other real property, or other collateral 16 to finance the purchase, thereby becoming the mortgagor in the transaction.

A financial institution (FI) 18, the second party, lends money to the homeowner to finance the house purchase, thereby becoming the mortgagee in the transaction. The FI 18 could be a commercial bank, a thrift institution, a credit union, an insurance company, or any other type of enterprise in the business of originating home mortgages. This process is fundamentally the same as the origination of any type of home mortgage or other collateralized borrowing, with the exception that the mortgage or other loan contract would incorporate the appropriate RM provisions, including a description of the means by which the mortgage interest rate will decrease in accordance with the interest-rate index or reference point specified in the mortgage note. The timing of the mortgage interest and principal payment and the manner in which the mortgage principal is amortized, or not amortized, is specified by the mortgage note.

While the FI 18 performs the functions of the mortgage originator, the mortgage owner, the mortgagee of the home 16, and possibly the servicer of the RM loan 24, as shown in FIG. 2, those functions may be allocated to various independent parties by contract, assignment, partnership, or other means. For example, the RM originator might sell the RM to a third party while the owner of the RM might contract with a third party to perform the servicing functions associated with the RM. This process is comparable to the functions associated with the sale of other types of mortgage securities, such as mortgage debt or mortgage-backed securities. The prospectus, offering circular, or other marketing materials for RPTs and/or RBs most likely will describe the RMs funded by the RPTs and/or RBs, the process by which both the RM interest rate and the RPT/RB interest rate are adjusted, and other features unique to RMs and RPTs/RBs.

The third party, the RPT/RB investors 20, represent the ultimate source of the funds lent to the homeowner 14. However, RPT/RB investors 20 typically do not lend directly to the homeowner 14. Instead, RPT/RB investors 20 lend funds to the FI 18, either directly or through a securitization trust. Hence, an RPT/RB investor 20 does not lend directly on a particular home mortgage; instead, a pool of RPTs/RBs funds a pool of RMs. Each RPT/RB has an undivided interest in that pool of RMs and has a secured interest if the pool of RMs is pledged to secure the pool of RPTs/RBs.

An FI 18 usually extends a binding interest-rate commitment to a homeowner before selling the RPTs/RBs or other debt securities that fund the RM. Two or three months may elapse from the time the FI 18 extends a binding interest commitment until the time the RPTs/RBs or other debt securities are sold. Interest rates can and usually do vary during this time period, sometimes substantially. To protect against interest-rate fluctuations during that time period, an FI 18 usually enters into an interest-rate hedging contract to “lock in” the interest-rate “spread” on the RM, which is the difference between the initial interest rate on the RM and the initial interest rate on the RPT/RB.

A record is kept of the linkage between the pool of RMs to the specific RPT/RBs funding that pool of RMs. These specific linkages include the identification of the specific RMs funded by a specific pool of RPT/RBs, the record-keeping associated with the terms and conditions of the RMs funded by the pool of RPT/RBs, and the determination of the principal and interest payments on the pool of RMs that flows or passes through to the owners of the RPT/RBs funding those RMs.

Investment banking firms or other financial intermediaries 22, the fourth party, underwrite the sale of RPTs/RBs to the RPT/RB investors 20. In effect, the investment banking firms 22 act as intermediaries between the FI 18 and the RPT/RB investors 20. Because large FIs, such as Citigroup and JP Morgan Chase, have investment banking affiliates and extensive direct dealings with RPT/RB investors 20, FIs 18 may sell RPTs and RBs directly to RPT/RB investors 20. The FI 18 also may act as the mortgage servicer 24, as shown in FIG. 2.

Servicing the mortgage, as shown in FIG. 2, includes billing the homeowner for periodic mortgage payments; collecting the payments; collecting, escrowing, and paying insurance premiums, property taxes, and other fees to protect the mortgagee's interests; dealing with delinquent loans; foreclosing when necessary on seriously delinquent loans and selling the foreclosed home 16; and otherwise administering the RM over its life. In addition, servicing of the RM includes accounting for periodic changes in (1) the RM interest rate, (2) the amount of the periodic payment on the RM, (3) the amortization of the RM principal triggered by a change in the RM interest rate, and (4) the maturity of the RM due to an increase in the RM's principal balance during the term of the RM. Addressing periodic changes in these factors is comparable to what occurs with the loan servicing of conventional ARMs.

While the RPTs and/or RBs are outstanding, they may have an independent bond trustee 26, the fourth party shown in FIG. 2, who acts as the fiduciary for the RPT/RB investors 20 to ensure that payments are received in a timely manner and that the payment amounts have been correctly adjusted for changes in the interest-rate index to which the RPTs/RBs are tied. The mortgage servicer 24 may make these payments through the bond trustee 26 or directly to the bond investors of record 20. This is a typical bond-servicing arrangement, except that the mortgage servicer 24 will have to factor into the periodic payments any interest-rate reductions which have occurred due to the operation of the RPT/RB's ratcheting feature.

Over the lifetime of the RM, the interest rate on the RM must be periodically adjusted. While comparable to the process for periodically adjusting the rate on an ARM, in the preferred embodiments of the invention, the rate on a RM only adjusts downwardly. That is, should the interest-rate index to which the RM interest rate is linked signal that the mortgage interest rate should rise, the rate remains at its previous level. It is the responsibility of the FI 18, as shown in FIG. 1, or its designated agent, such as the mortgage servicer, 24, shown in FIG. 2, to determine (1) when a rate adjustment is needed, (2) the amount of the rate adjustment, if needed, and (3) the amount of the dollar adjustment in the periodic mortgage payment made by the homeowner 14. The FI 18 or the mortgage servicer 24 then notifies the homeowner 14 of the amount of the rate change, the new mortgage payment amount, and the effective date of the changed payment.

Additionally, over the lifetime of the RM debt instrument, the interest rate on the RPT and/or RB may be periodically adjusted. In a manner that parallels the periodic adjustment of the RM interest rate, the FI 18, as shown in FIG. 1, or the mortgage servicer 24, as shown in FIG. 2, periodically adjusts the RPT and/or RB interest rate downward in accordance with the terms of the RPT and/or RB indenture, which defines the rate adjustment process. That is, should the interest rate index to which the RPT and/or RB interest rate is linked signal that the RPT and/or RB interest rate should rise, in the preferred embodiments of the invention, the rate remains at its previous level. It is the responsibility of the FI 18, or its designated agent, such as the mortgage servicer, 24, as shown in FIG. 2, to determine (1) that a rate adjustment is needed, (2) the amount of the rate adjustment, if needed, and (3) the amount of the dollar adjustment in the periodic payment the FI 18, another party, or the mortgage servicer 24 or bond trustee 26, as shown in FIG. 2, makes to the RPT/RB investors 20. The bond trustee 26, RPT/RB investors 20, or a designated agent verifies the size of the rate adjustment and the change in the amount of the periodic payment to RPT/RB investors 20 to ensure accuracy.

With reference to FIG. 3, there are also four parties involved with the steps of the present invention; the difference between FIG. 1 and FIG. 3 being that the borrower 14 is a former student and there is no mortgaged property 16.

With reference to FIG. 4, there are four parties involved with the steps of the present invention; the difference between FIG. 2 and FIG. 4 being that there is no mortgaged property 16 or other collateral to foreclose on should the former student or other borrower 14 default on the loan.

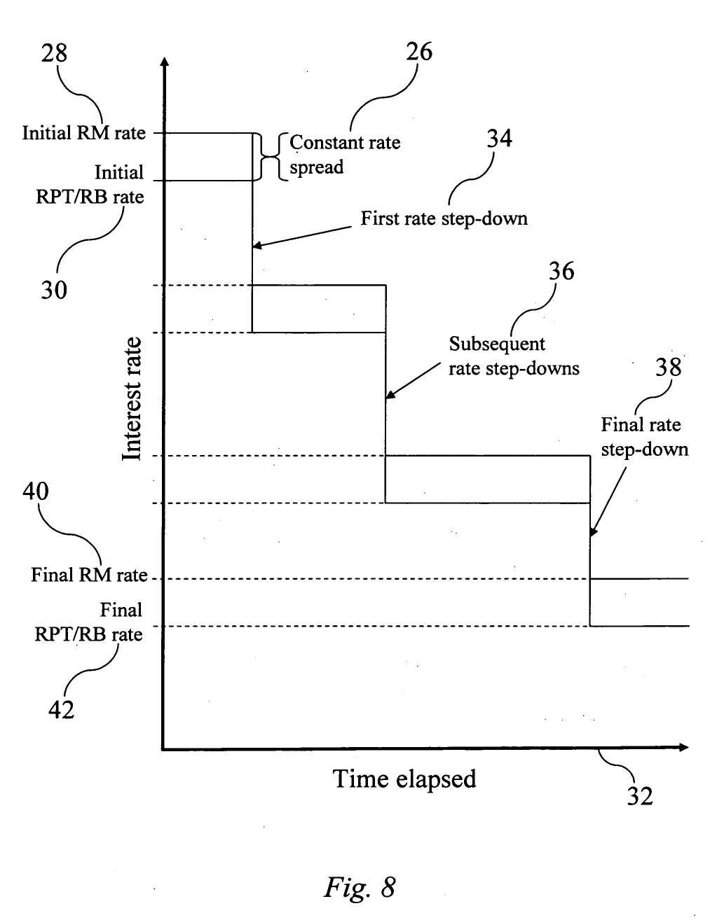

FIG. 8 shows how the lifecycle of an RPT or RB parallels the RM lifecycle. In particular, FIG. 8 shows how the rates on both instruments step down together while remaining perfectly hedged, and with a constant rate spread 26 between the initial RM rate 28 and the initial RPT/RB rate 30. In this embodiment of the invention, over a period of time 32, the rates step down from the initial RM rate 28 and the initial RPT/RB rate 30 to the first rate step-down 34, subsequent rate step-downs (if any) 36, and the final rate step-down (should there be more than one rate step down) 38 to the final RM rate 40 and the final RPT/RB rate 42.

It is therefore seen that by linking an RM to an RPT and/or RB, a new debt instrument can be created that has the flexibility and automatic interest rate adjustment of a conventional ARM with the upper-limit interest rate certainties of a conventional FRM. Through use of the system and method of the present invention, the need for refinancing to reduce the interest rate on a mortgage is eliminated, thereby saving the homeowner, the mortgage lender, and investors significant amounts of time and money.

The following preferred embodiments of the present invention provide a number of advantages. It should be noted, however, that these advantages may not necessarily be present in all embodiments of the present invention and that some of the embodiments may not have any of the specific advantages discussed below.

Ratchet Financing (another term to describe the RM/RB invention) benefits for homeowners:

initial RM rate comparable to the rate on a conventional fixed-rate mortgage;

no need to decide when to refinance—refinancing effectively occurs automatically, at the optimal time, when the RM interest rate ratchets down;

zero cost when the RM rate ratchets down—no more spending several thousand dollars to get a ½% rate cut;

no credit qualification—everyone contractually entitled to a rate cut gets it, at the same time;

no paper work—the homeowner is merely notified of the new, lower monthly payment;

HELOCs and other junior mortgages stay in place; and

An ability to borrow more when the rate resets—just like a cash-out refinance

Homeowners who most benefit from Ratchet Financing:

Credit-impaired home owners, who benefit more from a lower monthly payment than many who can easily refinance;

the financially unsophisticated;

busy people and those who neglect their personal finances;

low-income, minority, and immigrant homeowners; and

homeowners with relatively small mortgages, for whom refinance origination costs often do not make refinancing worthwhile.

The RPT—a perfect hedge for the RM:

An RPT is a perfect hedge for an RM because:
(1) both financial instruments are tied to the same interest-rate, swap rate, or other index;
(2) the interest rate on both instruments adjusts in the same manner and has the same effective date;
(3) all principal payments received from homeowners are passed directly through to RPT investors.

Ratchet Financing substantially reduces interest-rate risk

Ratchet Financing eliminates these elements of interest-rate risk
(1) maturity mismatching;
(2) basis risk, if both instruments utilize the same index;
(3) volatility risk;
(4) yield curve risk;
(5) duration and convexity risk

Ratchet Financing greatly reduces prepayment risk
(1) no incentive for homeowners to refinance;
(2) early payoffs, due to demographic factors, such as the sale of the mortgaged home, are more predictable

No FAS 133/FAS 149 accounting risk

Practical elimination of related operational risks

Ratchet Financing benefits for mortgage originators:
lower origination cost for purchase mortgages;
greatly reduced volatility in origination activity;
   (1) no more ramping up for refinance booms and then gearing down when rates rise

greater opportunity to retain ownership of RMs than with conventional FRMs;

no refinance origination costs to recover;

reduced servicing costs from the near-elimination of servicing portfolio churning due to refinances;

servicing portfolio hedging not needed if RMs
(1) held in portfolio
(2) sold without a servicing profit to capitalize

Longer retention of customers
(1) refinancings often shift borrowers to another lender
(2) greater cross-selling opportunities as a result

Payoffs to investors now investing in Fannie/Freddie MBS:

Elimination of nearly all return of principal due to interest rate driven refinances
(1) An RM's automatic rate cuts plus the homeowner's ability to borrow more at rate reset time eliminates the major reason mortgages prepay—the borrower's desire to obtain a lower mortgage interest rate
(2) greatly reduces pre-payment hedging costs

Greater predictability of the receipt of cash flows to reinvest
(1) Less to reinvest in any one period

RPTs have a longer average life than conventional FRMs, particularly when interest rates are declining

Greatly reduced hedging and transaction costs

The following examples are provided to further illustrate the present invention. This example is not intended to limit the scope of the claimed invention in any manner.

### EXAMPLE 1

### Originating a Ratchet Mortgage

(a) Step 1—Fixed-rate commitment made upon approval of the RM application

(b) Step 2—Mortgage origination pipeline risk hedged in the usual manner

(c) Step 3—If the RM rate index drops sufficiently between the commitment date and loan closing, the RM rate automatically drops
This feature reduces pipeline fallout

(d) Step 4—The RM closes in the usual manner

(e) Step 5—If not sold, the RM is funded with short-term debt until pooled with other RMs for permanent RPT or RB funding

(f) Step 6—A pool of RMs funded by RPTs and/or RBs can be held on balance sheet or placed in a bankruptcy-remote trust

(g) Step 7—Equity cushion for an RM pool provided in the normal manner—over-collateralization, third-party guarantees, buy-back provisions, etc.

(h) Step 8-—RMs serviced in the normal manner.

### EXAMPLE 2

### Ratchet Bond Issuance and Servicing

(a) Step 1—RPTs or RBs issued to fund a sufficiently large pool of RMs

(b) Step 2—The RM servicer monitors RM and RPT or RB indices to determine if, under the terms of their respective contracts the rate on the RM and the RPT and/or RB should drop
If a rate drop is signaled, the servicer adjusts the monthly payment and amortization schedule for the RMs and makes corresponding adjustments for the RPTs and/or RBs

(c) Step 3—Principal and interest paid on RMs passed through to RPT and/or RB investors, net of a spread to cover servicing, credit losses, and compensation for the equity cushion.

Many changes and modifications of the description of the present invention will occur to one skilled in the art upon studying the specifications. All such changes and modifications which fall within the spirit of the described invention are intended to be included within the scope of the claims.

We claim:

1. A financial product which comprises:
a debt instrument having a debt interest rate which is decreased when interest rates go down but which is never increased;
a bond having a bond interest rate, said debt instrument and said bond being linked so that if one of the debt interest rate or the bond interest rate is decreased, the other of the debt interest rate and the bond interest rate is decreased, said debt and said bond interest rates being decreased when interest rates for debt instruments decline.

2. The financial product of claim 1 wherein the note interest rate is adjusted down in a predetermined manner and the bond interest rate is adjusted down in a preselected manner.

3. The financial product of claim 2 wherein the debt instrument is a promissory note.

4. The financial product of claim 2 wherein the debt instrument is a promissory note and wherein the financial product further comprises a mortgage lien.

5. The financial product of claim 3 wherein the note interest rate is adjusted down using at least one predetermined index and the bond interest rate is adjusted down using at least one preselected index.

6. The financial product of claim 5 wherein the predetermined index is the same as the preselected index.

7. The financial product of claim 3 wherein the note interest rate is adjusted down by reference to at least one financial index and the bond interest rate is adjusted down using at least one financial index.

8. The financial product of claim 3 wherein the note interest rate is adjusted down by reference to at least one interest index and the bond interest rate is adjusted down using at least one interest index.

9. The financial product of claim 3 wherein the note interest rate is adjusted down by reference to at least one non-financial index and the bond interest rate is adjusted down using at least one non-financial index.

10. The financial product of claim 3 wherein the note interest rate is adjusted down so as to keep the spread between said note interest rate and said bond interest rate the same or substantially the same as prior to the adjustment.

11. The financial product of claim 3 further comprising:
a CPU;
a computer code associated with said CPU for adjusting down in a predetermined manner the note interest rate and for adjusting down in a preselected manner the bond interest rate.

12. The financial product of claim 11 further comprising an additional code for computing whenever the note interest rate is adjusted down, at least one of: new amortization schedule for the note and the new schedule of payments.

13. The financial product of claim 12 further comprising additional code for computing, whenever the bond interest rate is adjusted down, at least one of: interest payment on the bond, and principal amortization schedule for the bond, and a new maturity date of the bond.

14. A financial product which comprises:
one or more debt instruments having an interest rate which is adjustable down but is not adjustable up and where the adjustment being based on a specified index or on a specified interest rate adjustment of said bond;
one or more bonds whose interest rate is adjustable down but is not adjustable up the adjustment is based on a specified index or the interest rate adjustment of said debt instruments.

15. The financial product of claim 14 wherein the terms of the debt instruments and/or the bonds have been set so that their respective interest rates are adjusted so as to remain substantially parallel.

16. A method for financing a loan or a pool of loans by using a note or a pool of notes and a linked bond, said method comprising the following steps:
(a) decreasing the note interest rate in a predetermined manner;
(b) calculating at least one of a new periodic payment amount and an adjusted amortization schedule for the note whenever the note interest rate is decreased;
(c) decreasing the bond interest rate in a preselected manner; and
(d) calculating at least one of the interest payment on and principal amortization schedule for the bond whenever the bond interest rate is decreased.

17. The method of claim 16 wherein steps (a) through (d) are implemented by a computer.

18. The method of claim 17 wherein the step of decreasing the note interest rate comprises:
obtaining at least one specified interest rate index and implementing step (a) if the potential adjusted note interest rate declines from the current note interest rate by a predetermined amount.

19. The method of claim 17 wherein the note interest rate and the bond interest rate are decreased based on the same index.

20. The method of claim 17 wherein the note interest rate and the bond interest rate are decreased based on different indices.

21. The method of claim 17 wherein the step of decreasing the note interest rate and the bond interest rate are carried out to maintain substantially the same spread between the note interest rate and the bond interest rate.

22. A financial product comprising:
a mortgage lien on real estate;
a mortgage note for a specified sum and a specified term, said mortgage note being associated with said mortgage lien, said mortgage note providing for a decrease of the note interest rate Whenever a specified interest rate index or specified interest rate decline by a specified amount;
a bond for the same sum as the mortgagor note, said bond being linked to said mortgage note so that when said note interest rate is decreased, the bond interest rate is decreased in a predetermined manner.

23. A financial product comprising:
a pool of mortgage notes and mortgage liens associated with the notes, said mortgage notes providing for a decrease of each note's interest rate whenever a specified interest rate index or specified interest rate decline by a specified amount;
a pool of bonds for the same sum or a lesser amount as the pool of mortgage notes, said pool of bonds being linked to said pool of mortgage notes so that when said note interest rates are decreased, the bond interest rate is decreased in a predetermined manner.

24. A financial product comprising:
a promissory note for a student loan, said note providing for a decrease of the interest rate whenever a specified interest rate index or specified interest rate indices decline by a specified amount;
a bond for the same sum or a lesser amount as the promissory note or pool of promissory notes, said bond being linked to said promissory note, or pool of promissory notes so that when said note interest rate is decreased, the bond interest rate is decreased in a predetermined manner.

25. A financial product comprising:
a pool of promissory notes for student loans, each of said notes providing for a decrease of the interest rate on the note whenever a specified interest rate index or specified interest rate indices decline by a specified amount;
a pool of bonds for the same sum or a lesser amount as the pool of promissory notes, said pool of bonds being linked to said pool of promissory notes so that when the interest rate on the notes is decreased, the interest rate on the bonds is decreased in a predetermined manner.
